(19) United States
(12) Patent Application Publication
(10) Pub. No.: US 2010/0031527 A1
(43) Pub. Date: Feb. 11, 2010

(54) Next generation dryer vent system

(75) Inventors: James Phillip Robinson, Cedar Hill, TX (US); Jackie Perry Robinson, Cedar Hill, TX (US)

Correspondence Address: JAMES PHILLIP ROBINSON, 222 RAMSEY STREET, CEDAR HILL, TX, 75104, US

(73) Assignee: JAMES PHILLIP ROBINSON, Cedar Hill, TX (US)

(21) Appl. No.: 12/462,269

(22) Filed: Aug. 3, 2009

Related U.S. Application Data
(60) Provisional application No. 61/137,752, filed on Aug. 1, 2008.

(51) Int. Cl. F26B 25/08

(52) U.S. Cl. 34/235

(57) ABSTRACT

A dryer vent contains one to three components that connect the dryer from the dryers exhaust port to the wall connection port where the air flow is directed to the outside of the business or residence. The Next Generation Dryer Vent System is composed of two end units that have a universal fitting and they are connected by a flexible rectangular tube allowing for the dryer to be closer to the back wall in which current available products leak or fail. The universal fittings allow for a proper seal while maintaining flexibility the end units transfer the heat from one end to the other thru the tubing to the outside port exhaust.

### BACKGROUND OF THE INVENTION

This invention which is called THE NEXT GENERATION DRYER VENT SYSTEM relates to the exhaust vent system for clothes dryers.

Clothes dryers produce a lot of heat and lint from clothing which is blown through the dryers exhaust system to an external system that is connected to the dryer and then to another exhaust system in the wall of the residence to the outside.

The problems with the current products that are available to the consumer that make the connection from the dryer to the wall are as follows. The Elbow and round vent tube systems are large and work sufficiently for large laundry rooms, but become crushed in smaller laundry rooms due to clearance needed to open doors going into the laundry room. The current more flexible round vents become compressed and cut of the air flow. The other available type for the smaller laundry rooms are square metal box with attachments. This requires the consumer to have to adjust and cut the metal for it to fit, but does not seal well which causes lint and heat to escape into the room. Also, with a number of code changes by cities, the current systems are hard to adapt to the exhaust systems that are being installed to exhaust the heat and lint through the wall to the outside.

My invention The Next Generation Dryer Vent System solves this problem. It is specifically designed for the smaller laundry rooms, but will work in larger laundry rooms also, and adapts to the new city code requirements for the wall exhaust system. It connects to the dryer using a universal connection which is part of the air flow chamber through a rectangular or oval vent duct which is flexible and expandable, thru another air flow chamber with a universal fitting that attaches to the wall port. This end can be removed to allow the vent tube portion to attach directly to the new exhaust port that city codes are requiring. This invention can be made with metal or high temp plastic polymers, but metal is preferred.

The low profile shape of the air flow chambers and vent duct greatly reduces the amount of room needed, which allows more clearance in the front of the dryers room entry doors to open or closet doors to close. It also has the flexibility for pulling out the dryer for service personnel.

### SUMMARY OF INVENTION

The object of this invention is to provide a dryer ventilation system that will function in smaller laundry rooms where the conventional duct system does not work.

Many of the new homes do not allow for proper venting of the unit, which usually results in crushed ducts, which causes premature failure of components, and heavy lint build up.

This system was specifically designed for small laundry rooms that are in todays homes and apartments. This system will allow proper air flow as long as the dryer is working correctly and the main exhaust to the outside is clear and clean.

This system also has the flexibility of the tubing which will make it easier for service personnel to perform maintenance.

### BRIEF DESCRIPTION OF DRAWING

FIG. 1 is the air flow chamber with a universal adapter that attaches to the dryer exhaust port, and to the vent tube assembly;

FIG. 2 is the air flow chamber with a universal adapter that attaches to the wall port exhaust that goes thru the wall to the outside of the room or residence;

FIG. 3 is the vent tube that connects the two air flow chambers together, shown in a non expanded view;

FIG. 4 is the vent tube that connects the two air flow chambers together, shown in an expanded view;

FIG. 5 is a view of the air flow chambers attached together using the vent tube and clamps. This view also shows that the system is flexible.

FIG. 6 is a view of all components unassembled and positioned in order of attachment.

FIG. 7 is the assembled view of the system shown flexed and in position for attachment to dryer port indicated as item 40 and wall port indicated as item 41. Item 2000 is the identifier for the complete system.

### DESCRIPTION OF EMBODIMENT

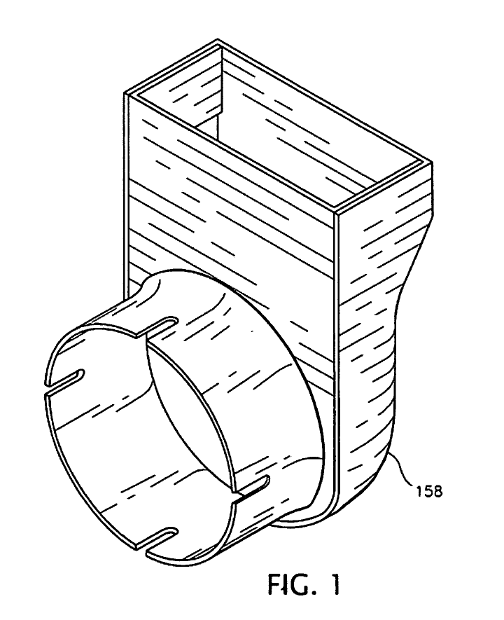

Referring to FIG. 1 is the air flow chamber identified as 158, has a universal adapter that attaches to the dryer. The universal fitting on the air flow chamber that attaches to the dryer is rotatable on the axis of the chamber. The universal fitting is attached to the flat side of the air flow chamber. The main body of the air flow chamber is curved above the universal fitting and expands toward the vent tube side where it can be either rectangular or oval depending on the vent tube. This creates a low profile without changing the dynamics of the air flow.

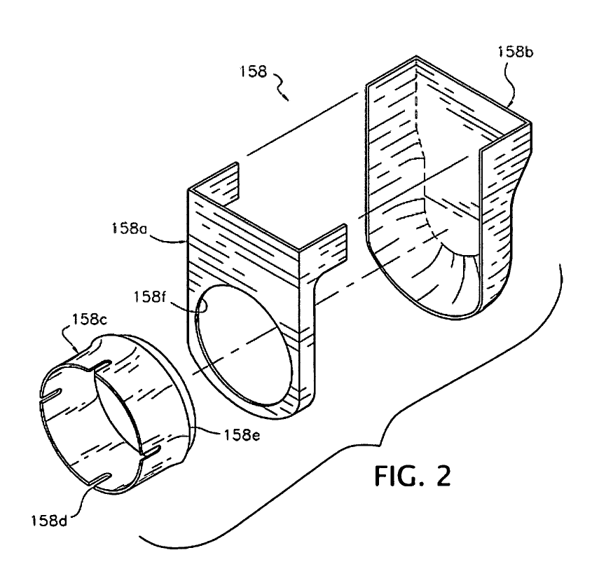

Referring to FIG. 2 is the breakdown of the airflow chamber. 158c has groves identified as 158d. This is on the universal connector on the dryer side, which allows for a better fit. 158c is into the hole of 158a in the position marked 158d. 158a is connected to 158b by sliding or crimping the two components edges to hold it in place to complete 158 assembly.

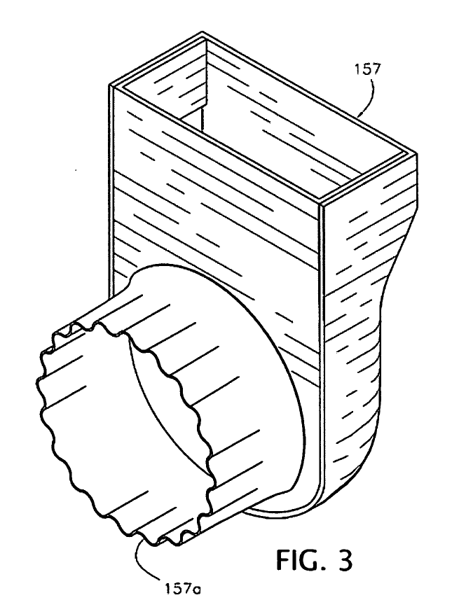

Referring to FIG. 3 is the air flow chamber with a universal adapter that attaches to the wall port is rotatable on the axis of the chamber. The universal fitting is attached to the flat side of the air flow chamber. The main body of the air flow chamber is curved above the universal fitting and expands toward the vent tube side where it can be either rectangular or oval depending on the vent tube. This creates a low profile without changing the dynamics of the air flow.

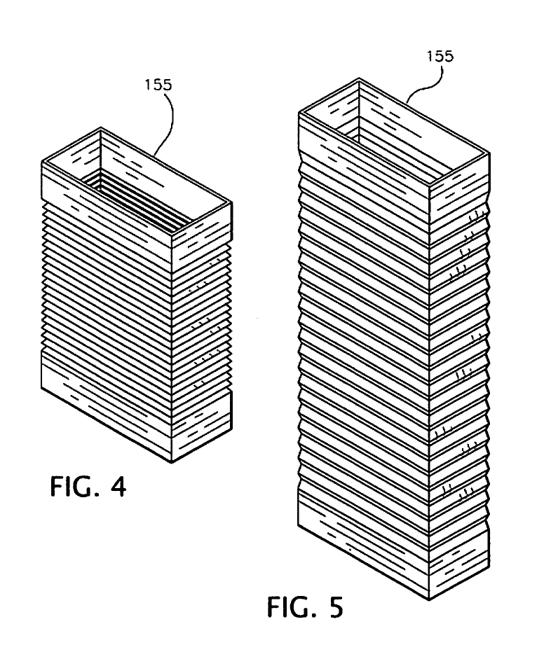

Referring to FIG. 4 is the non expanded view of the vent duct. It is rectangular or can be oval depending on the application. The duct is corrugated to allow flexibility. One end attaches to the air chamber for the dryer and the other attaches to the air chamber for the wall port. The wall port does not have to be uses when attaching directly to the new code required exhaust which is inset into the wall.

Referring to FIG. 5 is the expanded view of the vent duct. It is rectangular or can be oval depending on the application. The duct is corrugated to allow flexibility. One end attaches to the air chamber for the dryer and the other attaches to the air chamber for the wall port. The wall port does not have to be uses when attaching directly to the new code required exhaust which is inset into the wall.

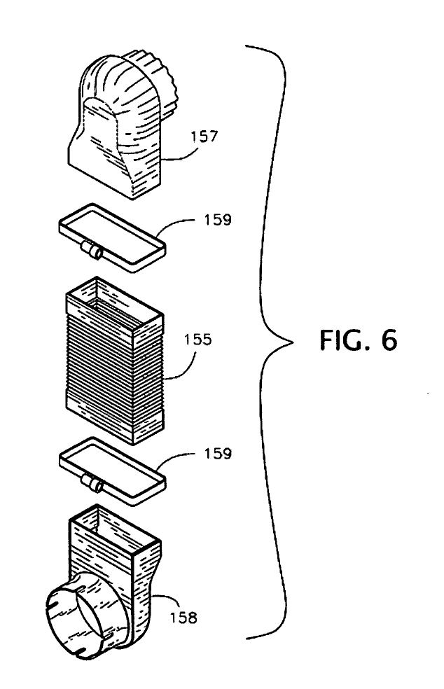

Referring to FIG. 6 is the expanded view of all components laid out in order and direction of assembly.

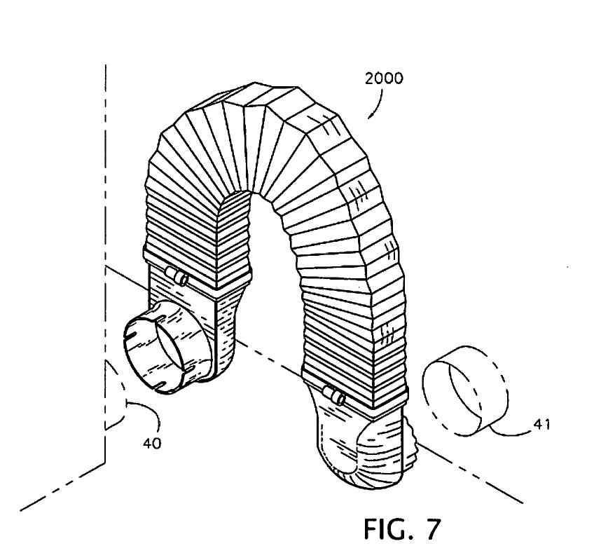

Referring to FIG. 7 Shows the completed Next Generation Dryer Vent System with all components connected. In addition it shows the system vent duct in a flex position. Although this invention could either be oval or rectangular to achieve the low profile effect this drawing is showing it in rectangular design. This drawing also indicates the air flow chamber universal fitting on the dryer side and the air flow chamber with the universal fitting on the wall port side.

The embodiments of the invention which is a exclusive property, design or privilege is claimed are defined as follows:

1. An rectangular air flow duct assembly comprised of:
A flexible rectangular, flexible metal, corrugated duct having a male air flow chamber with a male universal adapter on one end and a air flow chamber on the opposite end with a universal female adapter fitting.
Each ends universal fitting is attached to the end air flow chambers and can rotate 360 degrees around the axis of the port. Each air chamber connects to the rectangular duct form a complete system.

2. The assembly in claim one when connected to a dryer that is working correctly and attached to a wall exhaust that is in good working order will provide good transport of the heat to the residential or business exhaust.

3. The assembly in claim 1, will also the dryer to be close to the wall, which for small laundry rooms is essential.

4. The assembly in claim 1, also resist crushing, and will meet the connection requirements for the new building codes.
